(19) United States
(12) Patent Application Publication
(10) Pub. No.: US 2010/0196739 A1
(43) Pub. Date: Aug. 5, 2010

(54) MAGNETIC HEAD, MANUFACTURING METHOD THEREFOR AND MAGNETIC TAPE DEVICE

(75) Inventors: Nozomu Hachisuka, Tokyo (JP); Yoshiyuki Mizoguchi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TDK CORPORATION, Tokyo (JP)

(21) Appl. No.: 12/366,262

(22) Filed: Feb. 5, 2009

(51) Int. Cl. G11B 5/33; G11B 5/127; B32B 37/14

(52) U.S. Cl. 428/816; 360/110; 156/60; G9B/5.04

(57) ABSTRACT

The present invention relates to a magnetic head which can be kept in stable contact with a magnetic tape and has improved production efficiency, a manufacturing method therefor, and a magnetic tape device. The magnetic head according to the present invention includes a substrate and two auxiliary members, having a tape bearing surface to be in sliding contact with a magnetic tape. Reproducing and recording elements in alignment with each other along a tape running direction are arranged in the substrate along a tape width direction. The two auxiliary members are joined to two ends, respectively, of the substrate, constituting the tape bearing surface together with the substrate. The substrate or the two auxiliary members are formed with slopes extending from join-faces between the substrate and the two auxiliary members to the tape bearing surface to make clearances for the magnetic tape. Since the running magnetic tape can be drawn to the clearances by negative pressure generated at the clearances, it can be held in parallel with the tape bearing surface.

### TECHNICAL FIELD

The present invention relates to a magnetic head, a manufacturing method therefor and a magnetic tape device.

### BACKGROUND OF THE INVENTION

Recently, the importance of data backup for data erasure problem has increased with increase in volume of data to be stored in an information processing device such as a server. As a device for backing up large-volume data, there has been widely used a magnetic tape device exemplified by LTO (Liner Tape-Open). In the case of LTO, as much as 1.6 Tbytes data can be recorded on a half-inch width magnetic tape at a transmission rate of 120 Mbytes/sec or more.

The magnetic tape device is provided with a magnetic head for recording data on a magnetic tape or reading data recorded on the magnetic tape. The magnetic head is of the linear recording type, wherein since data is to be recorded and reproduced at every track defined along a longitudinal direction of the magnetic tape, a plurality of recording and reproducing elements for each track are arranged along a magnetic tape width direction. Typically, the magnetic head has recording and reproducing elements for 16 channels.

In the production of the magnetic head, accordingly, even when only one element for one channel is malfunctioning, the entire device becomes a defective product. Hence, if there is adopted a method of integrally obtaining a magnetic head from a wafer, including a portion where the recording and reproducing elements do not exist, the yield will be extremely lowered.

On the other hand, instead of the above method, there is another method, in which after obtaining a substrate that includes the recording and reproducing elements for all the tracks from a wafer, separately-formed two auxiliary members that do not include the recording and reproducing elements are adhered to its two end faces, respectively, in the tape width direction. This method is very advantageous in view of production efficiency since the number of substrates that can be obtained from a single wafer can be increased.

In the case of adopting this manufacturing method, however, when the substrate and the auxiliary members are adhered together, height positions of the TBSs (Tape Bearing Surfaces) are required to correspond with a high accuracy, making it difficult to further improve production efficiency. If their height positions are different from each other, there will be a problem that the tape bearing surface has steps, resulting in increasing the frictional heat between the magnetic tape and the magnetic head, and in addition, the steps of the tape bearing surface may cause a large space between the magnetic tape and the magnetic head, causing a problem of reducing power of reading or writing signals, so-called spacing loss.

In order to solve the above problems, there may be adopted a method of stabilizing contact between the magnetic tape and the magnetic head, for example, by applying a guide member to the magnetic head as disclosed in Japanese Unexamined Utility-Model Application Publication No. 5-73728, but eventually, it is less-than-effective because high accuracy is required for formation of a groove in the guide member and adhesion to the magnetic head.

### SUMMARY OF THE INVENTION

It is an object of the present invention to provide a magnetic head which can be kept in stable contact with a magnetic tape and has improved production efficiency, a manufacturing method therefor, and a magnetic tape device.

### 1. Magnetic Head

In order to solve the above problems, the magnetic head according to the present invention comprises a substrate and two auxiliary members, having a tape bearing surface to be in sliding contact with a magnetic tape.

Reproducing and recording elements in alignment with each other along a tape running direction are arranged in the substrate along a tape width direction.

The two auxiliary members are joined to two ends, respectively, of the substrate, constituting the tape bearing surface together with the substrate.

The substrate or the two auxiliary members are formed with slopes extending from join-faces between the substrate and the two auxiliary members to the tape bearing surface to make clearances for the magnetic tape.

When kept in contact with the magnetic tape, the magnetic head with the slopes formed in the substrate or the two auxiliary members makes clearances. The clearances are formed along the tape running direction as two grooves in the tape bearing surface and generate negative pressure as the magnetic tape runs, so that the magnetic tape can be drawn to the clearances by atmospheric pressure. Hence, the running magnetic tape can be suitably kept in parallel with the tape bearing surface.

In addition, since the clearances are formed at the boundaries between the substrate and the two auxiliary members in the tape bearing surface, the tape bearing surface does not have any step between the substrate and the two auxiliary members. Accordingly, the above-described problems of frictional heat and spacing loss can be avoided. Thus, the magnetic head according to the present invention can be kept in stable contact with the magnetic tape at the tape bearing surface.

In the magnetic head according to the present invention, moreover, since the above-described high-accuracy adjustment of the substrate and the two auxiliary members for the height position of the tape bearing surface is no more required because of having the clearances, the production efficiency can be improved.

### 2. Method for Manufacturing a Magnetic Head

The method for manufacturing a magnetic head according to the present invention is a method for manufacturing a magnetic head with a tape bearing surface to be in sliding contact with a magnetic tape, as described above.

In the manufacturing method, prior to constituting the tape bearing surface by joining two auxiliary members to two ends, respectively, of a substrate whose reproducing and recording elements in alignment with each other along a tape running direction are arranged along a tape width direction, the substrate or the two auxiliary members are formed with slopes extending from join-faces between the substrate and the two auxiliary members to the tape bearing surface to make clearances for the magnetic tape.

Since the foregoing magnetic head can be obtained according to the magnetic head manufacturing method of the present invention, it is obvious that it can obtain the same effects as above.

### 3. Magnetic Tape Device

The magnetic tape device according to the present invention comprises a magnetic tape driving means and a magnetic head.

The magnetic tape driving means is adapted to run a magnetic tape along a tape running direction.

The magnetic head is the foregoing magnetic head, and the tape bearing surface is adapted to be kept in sliding contact with the magnetic tape for writing data on the magnetic tape with the recording element and reading data from the magnetic tape with the reproducing element.

Since the magnetic tape device of the present invention includes the foregoing magnetic head, it is obvious that it can obtain the same effects as above.

The other objects, constructions and advantages of the present invention will be further detailed below with reference to the attached drawings. However, the attached drawings show only illustrative examples.

### BRIEF DESCRIPTION OF THE DRAWINGS

FIG. 1 is a configuration of a magnetic tape device according to the present invention;

FIG. 2 is a plan view of a magnetic head in FIG. 1, as seen from the tape bearing surface side;

FIG. 3 is a front view of the magnetic head in FIG. 1, as seen from the tape running direction;

FIG. 4 is a perspective view of a substrate;

FIG. 5 is a perspective view of an auxiliary member;

FIG. 6 is a plan view of a magnetic head according to another embodiment, as seen from the tape bearing surface side;

FIG. 7 is a front view of the magnetic head in FIG. 6, as seen from the tape running direction;

FIG. 8 is a perspective view of an auxiliary member according to another embodiment;

FIG. 9 is a plan view of a magnetic head according to still another embodiment, as seen from the tape bearing surface side;

FIG. 10 is a front view of the magnetic head in FIG. 9, as seen from the tape running direction;

FIG. 11 is a perspective view of a substrate according to still another embodiment;

FIG. 12 is a perspective view of an auxiliary member according to still another embodiment; and

FIGS. 13a-13d show steps of a method for manufacturing a magnetic head according to the present invention.

### DESCRIPTION OF THE PREFERRED EMBODIMENTS

FIG. 1 shows a configuration of a magnetic tape device according to the present invention. The magnetic tape device includes motors 4a, 4b, a plurality of guide pins 3, a magnetic head 1, and a controller 5. A magnetic tape 6 being a recording medium is housed in a cassette case or the like while being wound about a pair of reels 2a, 2b, and when it is set to the magnetic tape device, the portion extending between the pair of reels 2a, 2b is held by the plurality of guide pins 3.

The motors 4a, 4b being a magnetic tape driving means make the pair of reels 2a, 2b rotate through a power transmission system such as gears, whereby the magnetic tape 6 runs along tape running direction D1, D2. The motors 4a, 4b can be driven in either rotation direction, and when the magnetic tape 6 runs in the tape running direction D1, the pair of reels 2a, 2b are rotated such that the magnetic tape 6 is unwound from the reel 2a and taken up by the reel 2b. When the magnetic tape 6 runs in the tape running direction D2, the pair of reels 2a, 2b are rotated by the motors 4a, 4b such that the magnetic tape 6 is unwound from the reel 2b and taken up by the reel 2a. The running magnetic tape 6 is guided by the plurality of guide pins 3.

The magnetic head 1 is positioned such that it can be pressed against the magnetic tape 6 between the pair of reels 2a, 2b. The magnetic head 1 has a tape bearing surface 100 in sliding contact with the magnetic tape 6, writing data on the magnetic tape 6 with a recording element Ew and reading data from the magnetic tape 6 with a reproducing element Er.

The recording element Ew is an electromagnetic conversion element that converts an input electrical signal and applies a signal magnetic field to the magnetic tape 6 for writing data. On the other hand, the reproducing element Er is a MR element having TMR (Tunnel Magneto Resistance) effect or GMR (Giant Magneto Resistance) effect and perceives a signal magnetic field from the magnetic tape 6 and converts it to an electrical signal for reading data. The recording elements Ew and the reproducing elements Er are formed within the magnetic head 1 but partially exposed on the tape bearing surface 100.

The controller 5 is a control circuit board or the like which, according to an operation from the outside, controls not only the rotation of the motors 4a, 4b but also writing operation on the magnetic tape 6 with data output to the recording element Ew of the magnetic head 1 and reading operation from the magnetic tape 6 with data input from the reproducing element Er of the magnetic head 1.

The magnetic head 1 includes first and second head portions 11a, 11b having the recording and reproducing elements Ew, Er and first and second closures 12a, 12b of a rectangular prism shape having the same width as the head portions 11a, 11b. It should be noted that the first and second head portions 11a, 11b have the same structure and the first and second closures 12a, 12b also have the same structure. The magnetic head 1 is composed such that the first and second head portions 11a, 11b are joined to the first and second closures 12a, 12b, respectively, and the first and second closures 12a, 12b are further joined to each other in face-to-face relationship.

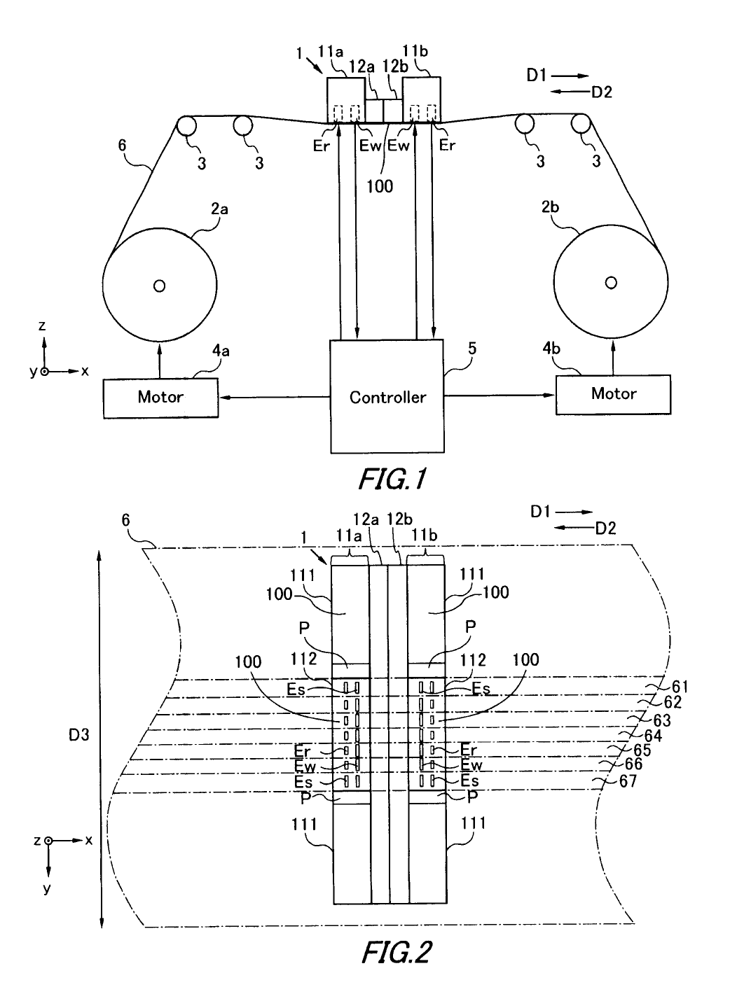

FIG. 2 is a plan view of the magnetic head 1 in FIG. 1, as seen from the tape bearing surface 100 side. The head portions 11a, 11b each include a substrate 112 and two auxiliary members 111 with the tape bearing surface 100 in sliding contact with the magnetic tape 6. That is, the magnetic head 1 has two pairs of the substrate 112 and the two auxiliary members 111.

In the substrate 112, the reproducing and recording elements Er, Ew in alignment with each other along the tape running direction D1, D2 are arranged along a tape width direction D3. At both ends of the array of the reproducing elements Er and at both ends of the array of the recording elements Ew, moreover, there are arranged servo elements Es for detecting the position with respect to the magnetic tape 6. The reproducing, recording and servo elements Er, Ew Es are disposed corresponding to tracks 61 to 67 defined along the tape width direction D3 of the magnetic tape 6 for performing reading from and writing on the corresponding tracks 61 to 67. It should be noted that the configuration of the tracks 61 to 67 is not limited to the illustrated one.

When the magnetic tape 6 runs along the tape running direction D1, the first head portion 11a has the reproducing element Er on the leading side and the recording element Ew on the tracking side, while the second head portion 11b has the reproducing element Er on the tracking side and the recording element Ew on the leading side. When the magnetic tape 6 runs along the tape running direction D2, on the other hand, the first head portion 11a has the reproducing element Er on the tracking side and the recording element Ew on the leading side, while the second head portion 11b has the reproducing element Er on the leading side and the recording element Ew on the tracking side.

In other words, one of the substrates 112 is disposed such that the reproducing element Er is located on the leading side with respect to the tape running direction D1, D2, and the other of the substrates 112 is disposed downstream of the one of the substrates 112 in the tape running direction D1, D2 such that the recording element Ew is located on the leading side with respect to the tape running direction D1, D2.

With the two head portions 11a, 11b being thus provided, during the writing operation, data can be written by the upstream side recording elements Ew of either one of the first and second head portions 11a, 11b, depending on the tape running direction D1, D2, while the written data can be read by the downstream side reproducing elements Er and checked by the controller 5 to confirm the normality of the writing operation. For example, when the magnetic tape 6 runs along the tape running direction D1, data is written by the recording elements Ew of the first head portion 11a, while the written data is read by the reproducing elements Er of the second head portion 11b.

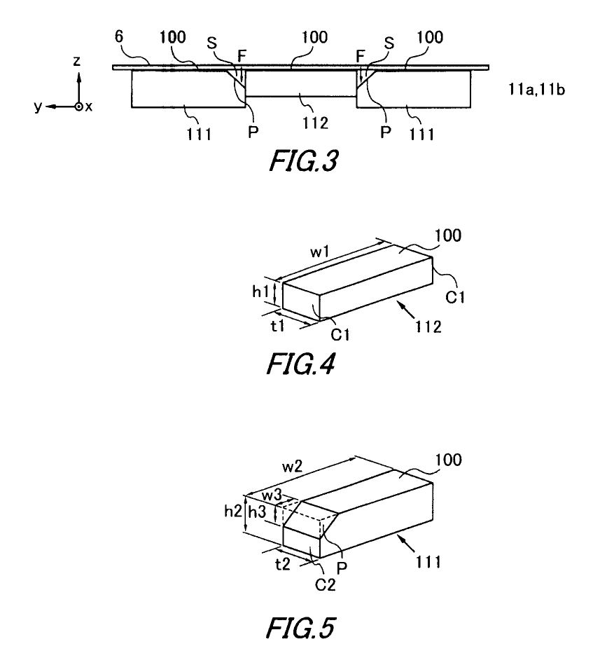

FIG. 3 is a front view of the magnetic head 1 in FIG. 1, as seen from the tape running direction D1, D2. In addition, FIG. 4 is a perspective view of the substrate 112, and FIG. 5 is a perspective view of the auxiliary member 111. The substrate 112 has a rectangular prism shape, while the auxiliary member 111 has a rectangular prism shape whose end including one side is cut off.

The two auxiliary members 111 are joined to two ends, respectively, of the substrate 112, constituting the tape bearing surface 100 together with the substrate 112. That is, the two auxiliary members 111 are joined to two end faces C1 of the substrate 112 in the tape width direction D3.

The two auxiliary members 111 are formed with slopes P extending from join-faces C2 between the substrate 112 and the two auxiliary members 111 to the tape bearing surface 100 to make clearances S for the magnetic tape 6. Concretely, the slope P is formed into a rectangular shape extending from the join-face C2 to the tape bearing surface 100. Accordingly, the clearance S is a space in the shape of a triangular prism whose height direction is taken along the tape running direction D1, D2.

When kept in contact with the magnetic tape 6, the magnetic head 1 with the slopes P formed in the substrate 112 or the two auxiliary members 111 makes the clearances S. The clearances S are formed along the tape running direction D1, D2 as two grooves in the tape bearing surface 100, and as the magnetic tape runs, they generate negative pressure, so that the magnetic tape 6 can be drawn to the clearances S by atmospheric pressure (see suction F in FIG. 3). Hence, the running magnetic tape 6 can be suitably kept in parallel with the tape bearing surface 100.

In addition, since the clearances S are formed at the boundaries between the substrate 112 and the two auxiliary members 111 in the tape bearing surface 100, the tape bearing surface 100 does not have any step between the substrate 112 and the two auxiliary members 111. Accordingly, the above-described problems of frictional heat and spacing loss can be avoided. Thus, the magnetic head 1 according to the present invention can be kept in stable contact with the magnetic tape 6 at the tape bearing surface 100.

In the present embodiment, therefore, the magnetic tape 6 can be kept in close contact with the reproducing and recording elements Er, Ew more reliably by projecting the substrate 112 from the two auxiliary members 111 toward the magnetic tape 6.

Moreover, since the clearances S are formed at two locations of the tape bearing surface 100 in the tape width direction D3, the suction F acts over the tape width direction D3, whereby the magnetic tape 6 can be stably held particularly in the tape width direction D3. With this, there can be obtained an effect that the magnetic tape 6 can be suitably prevented from rolling or the like.

Furthermore, the above-described closures 12a, 12b are joined to one end face of the substrate 112 and the two auxiliary members 111 in the tape running direction D1, D2, closing an open side of the clearance S. With this, the suction F for the magnetic tape 6 becomes more stable.

In the magnetic head 1 according to the present invention, still furthermore, since the above-described high-accuracy adjustment of the substrate 112 and the two auxiliary members 111 for the height position of the tape bearing surface 100 is no more required because of having the clearances S, the production efficiency can be improved.

The above effects can be similarly obtained by a magnetic tape device that is provided with the magnetic head 1 according to the present invention.

The magnetic head 1 according to the present invention is not limited to the above embodiment. Other embodiments of the magnetic head 1 will be described hereinbelow.

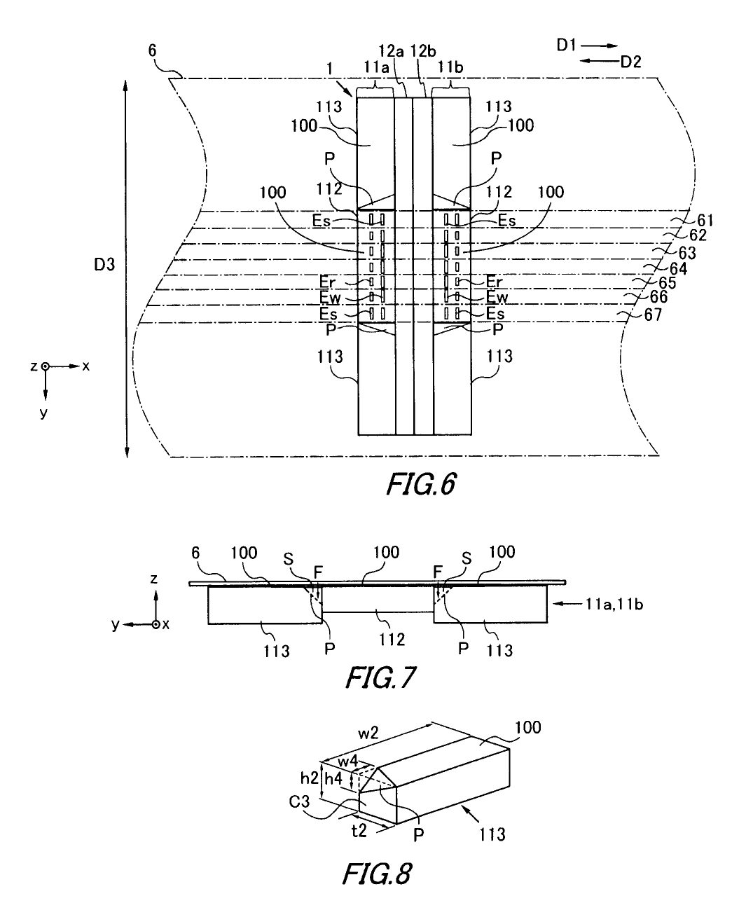

FIGS. 6, 7 and 8 are drawings of another embodiment corresponding to FIGS. 2, 3 and 5, respectively. The present embodiment differs from the foregoing embodiment in the shape of the slope P and the clearance S.

In the present embodiment, the slope P is formed such that the depth of the clearance S as measured from the running plane of the magnetic tape 6 varies in the tape running direction D1, D2 (i.e., the direction from the reproducing element Er to the recording element Ew). The slope P is formed such that the distance from the magnetic tape 6 (i.e., the distance in the direction Z in the drawings) increases along the tape running direction D1, D2, so that the clearance S is widened along the tape running direction D1, D2. Concretely, the slope P is formed into a triangular shape with one corner taken as vertex, wherein the clearance S has a triangular pyramid shape widening along the tape running direction D1, D2.

Here, as shown in FIG. 6, since the head portions 11a, 11b are each disposed such that the open side of the clearance S, i.e., the bottom face of the above triangular pyramid is directed to the closures 12a, 12b, the clearance S is widened in the direction from the reproducing element Er to the recording element Ew. That is, the slope P is formed such that the distance from the magnetic tape 6 (i.e., the distance in the direction Z in the drawings) increases in the direction from the reproducing element Er to the recording element Ew.

Therefore, the cross-sectional area of the clearance S along the tape width direction D3 decreases in the direction from the recording element Ew to the reproducing element Er, causing a difference in the suction F for the magnetic tape 6 between the reproducing element Er side and the recording element Ew side, depending on the tape running direction D1, D2.

In the case of the tape running direction D1, more specifically, the suction F in the first head portion 11a is stronger at the recording element Ew side than at the reproducing element Er side, while the suction F in the second head portion 11b is stronger at the reproducing element Er side than at the recording element Ew side. In the case of the tape running direction D2, on the other hand, the suction F in the first head portion 11a is stronger at the reproducing element Er side than at the recording element Ew side, while the suction F in the second head portion 11b is stronger at the recording element Ew side than at the reproducing element Er side.

These effects are very effective in the above-described writing operation including subsequent data confirmation. This is because in each of the head portions 11a, 11b, the magnetic tape 6 can be drawn more strongly to the functioning one of the reproducing and recording elements Er, Ew, depending on the tape running direction D1, D2, so that the writing operation can be performed more reliably.

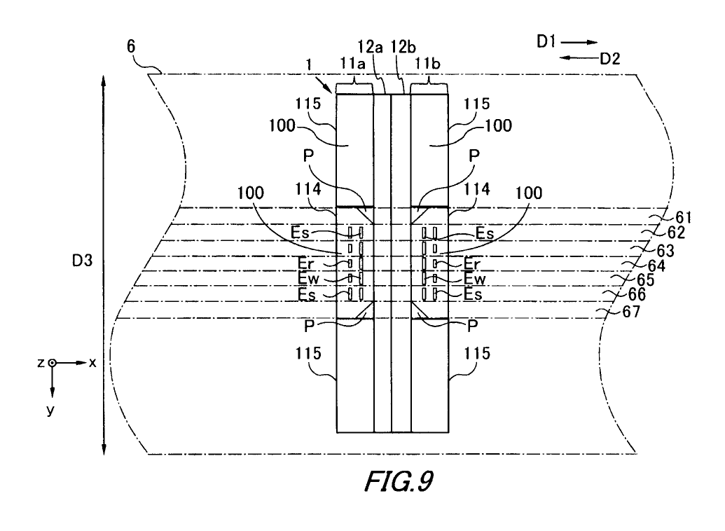

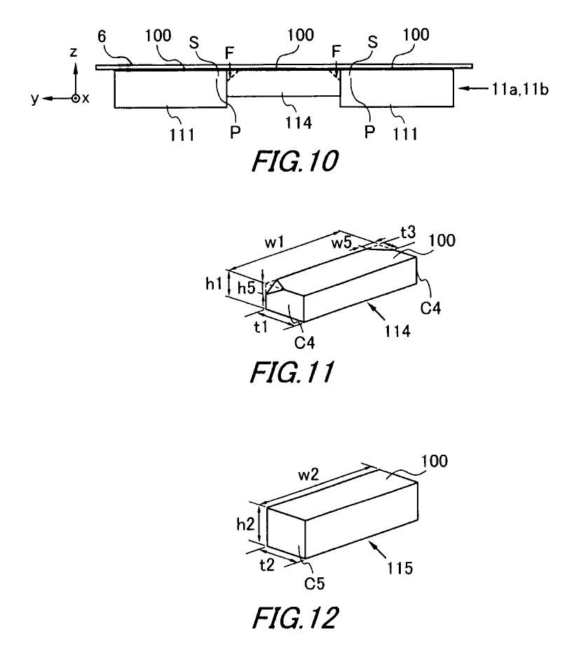

FIGS. 9, 10, 11 and 12 are drawings of still another embodiment corresponding to FIGS. 2, 3, 4 and 5, respectively. The present embodiment differs from the foregoing embodiment in that the slope P is formed in a substrate 114. In the present embodiment, auxiliary members 115 have a rectangular prism shape, while the substrate 112 has a rectangular prism shape whose adjacent two corners are cut off.

The slope P of the substrate 112 has a triangular shape extending from each end face C4, i.e., a face joined to a join-face C5 of the auxiliary member 115 to the tape bearing surface 100. Accordingly, the clearance S has a triangular pyramid shape widening along the tape running direction D1, D2. With the head portions 11a, 11b being disposed as shown in FIG. 9, therefore, the suction F can be made different between the recording element Ew side and the reproducing element Er side, so that the same effects can be obtained as in the foregoing embodiment.

For the substrates 112, 114 and the auxiliary members 111, 113, 115 described above, moreover, the optimum dimensions will be described below.

(1) Dimensions of the rectangular prism of the substrates 112, 114:
Width w1=4 (mm), Height h1=3 (mm), Depth t1=1 (mm).

(2) Dimensions of the rectangular prism of the auxiliary members 111, 113, 115:
Width w2=6 (mm), Height h2=5 (mm), Depth t2=1 (mm).

(3) Cut-off portion (i.e., portion indicated by dotted lines) of the auxiliary member 111 shown in FIG. 5:
Width w3=0.5 (mm), Height h3=0.5 (mm), Depth t2=1 (mm), wherein tolerance is such that 0 (mm)<w3<3 (mm), 0 (mm)<h3<3 (mm).

(4) Cut-off portion (i.e., portion indicated by dotted lines) of the auxiliary member 113 shown in FIG. 8:
Width w4=0.5 (mm), Height h4=0.5 (mm), Depth t2=1 (mm), wherein tolerance is such that 0 (mm)<w4<3 (mm), 0 (mm)<h4<3 (mm).

(5) Cut-off portion (i.e., portion indicated by dotted lines) of the substrate 114 shown in FIG. 11:
Width w5=0.5 (mm), Height h5=0.5 (mm), Depth t3=0.5 (mm), wherein tolerance is such that 0 (mm)<w5<3 (mm), 0 (mm)<h5<3 (mm).

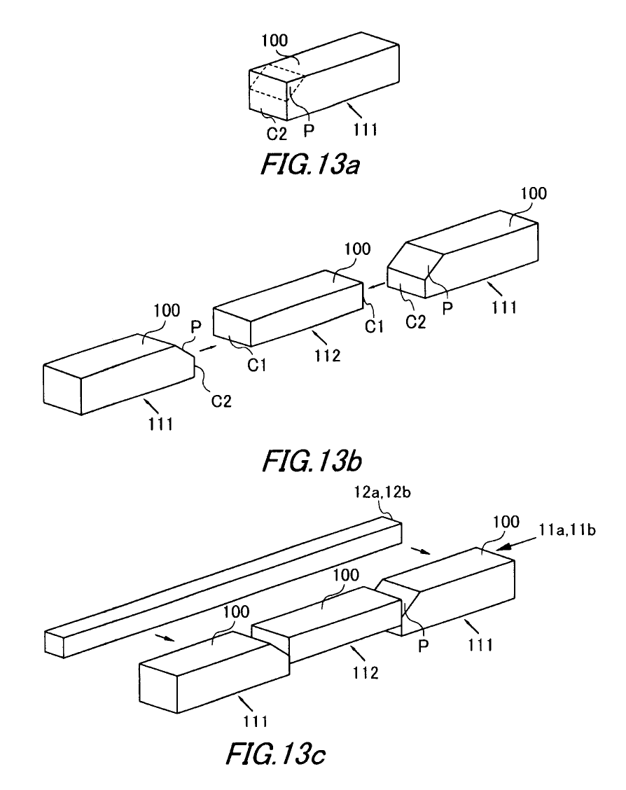

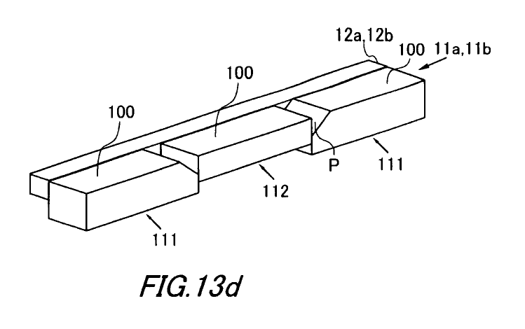

Next will be described a method for manufacturing the foregoing magnetic head 1. FIGS. 13a-13d show a part of the production process of the magnetic head. It should be noted that although the following description will be made only of the magnetic head 1 according to the embodiment shown in FIGS. 9 to 12, the same is true of the magnetic head 1 according to other embodiments.

The method for manufacturing a magnetic head according to the present invention is a method for manufacturing a magnetic head with the tape bearing surface 100 to be in sliding contact with the magnetic tape 6, as described above.

In the manufacturing method, prior to constituting the tape bearing surface 100 by joining the two auxiliary members 111 to the two ends Cl, respectively, of the substrate 112 whose reproducing and recording elements Er, Ew in alignment with each other along the tape running direction D1, D2 are arranged along the tape width direction D3, as shown in FIG. 13b, the two auxiliary members 111 (the substrate 114 in another embodiment) are formed with the slopes P extending from the join-faces C1, C2 between the substrate 112 and the two auxiliary members 111 to the tape bearing surface 100, as shown in FIG. 13a, to make the clearances S for the magnetic tape 6. It should be noted that the two ends C1 are two end faces of the substrate 112 in the tape width direction D3.

As means for forming the slope P, there may be adopted cutting or polishing. In the auxiliary member 113 shown in FIG. 8 and the substrate 114 shown in FIG. 11, moreover, the slope P should be formed such that the depth of the clearance S as measured from the running plane of the magnetic tape 6 varies in the tape running direction D1, D2 (i.e., the direction from the reproducing element Er to the recording element Ew), in other words, the distance from the magnetic tape 6 is widened along the tape running direction D1, D2. Preferably, as has been described above, the slope P is formed such that the distance from the magnetic tape 6 increases in the direction from the reproducing element Er to the recording element Ew.

As means for joining together the substrate 112 and the two auxiliary members 111, there may be adopted an adhesive. Moreover, as has been described above, it is desirable that the substrate 112 and the two auxiliary members 111 are joined together such that the substrate 112 projects from the two auxiliary members 111 toward the magnetic tape 6.

After the substrate 112 and the two auxiliary members 111 are joined together, as shown in FIG. 13c, the closures 12a, 12b are joined to one end face of the substrate 112 and the two auxiliary members 111 in the tape running direction D1, D2, closing an open side of the clearance S. Finally, the head portions 11a, 11b as shown in FIG. 13d can be obtained by entirely wrapping them with a wrapping tape or the like.

Since the foregoing magnetic head 1 can be obtained according to the magnetic head manufacturing method of the present invention, it is obvious that the same effects can be obtained as above.

The present invention has been described in detail above with reference to preferred embodiments. However, obviously those skilled in the art could easily devise various modifications of the invention based on the technical concepts underlying the invention and teachings disclosed herein.

What is claimed is:

1. A magnetic head comprising a substrate and two auxiliary members, having a tape bearing surface to be in sliding contact with a magnetic tape, wherein
reproducing and recording elements in alignment with each other along a tape running direction are arranged in said substrate along a tape width direction,
said two auxiliary members are joined to two ends, respectively, of said substrate, constituting said tape bearing surface together with said substrate, and
said substrate or said two auxiliary members are formed with slopes extending from join-faces between said substrate and said two auxiliary members to said tape bearing surface to make clearances for said magnetic tape.

2. The magnetic head of claim 1, wherein said two ends are two end faces of said substrate in said tape width direction.

3. The magnetic head of claim 2, wherein said slope is formed such that depth of said clearance as measured from a running plane of said magnetic tape varies in said tape running direction.

4. The magnetic head of claim 3, wherein said slope is formed such that the depth of said clearance as measured from the running plane of said magnetic tape varies in a direction from said reproducing element to said recording element.

5. The magnetic head of claim 4, comprising two pairs of said substrate and said two auxiliary members, wherein
one of said substrates is disposed such that said reproducing element is located on a leading side with respect to said tape running direction, and
the other of said substrates is disposed downstream of the one of said substrates in said tape running direction such that said recording element is located on the leading side with respect to said tape running direction.

6. The magnetic head of claim 2, further comprising a closure, wherein
said closure is joined to one end face of said substrate and said two auxiliary members in said tape running direction, closing an open side of said clearance.

7. The magnetic head of claim 1, wherein said substrate projects from said two auxiliary members toward said magnetic tape.

8. A method for manufacturing a magnetic head with a tape bearing surface to be in sliding contact with a magnetic tape, comprising
prior to constituting said tape bearing surface by joining two auxiliary members to two ends, respectively, of a substrate whose reproducing and recording elements in alignment with each other along a tape running direction are arranged along a tape width direction,
forming said substrate or said two auxiliary members with slopes extending from join-faces between said substrate and said two auxiliary members to said tape bearing surface to make clearances for said magnetic tape.

9. The magnetic head manufacturing method of claim 8, wherein said two ends are two end faces of said substrate in said tape width direction.

10. The magnetic head manufacturing method of claim 9, wherein said slope is formed such that depth of said clearance as measured from a running plane of said magnetic tape varies in said tape running direction.

11. The magnetic head manufacturing method of claim 10, wherein said slope is formed such that the depth of said clearance as measured from the running plane of said magnetic tape varies in a direction from said reproducing element to said recording element.

12. The magnetic head manufacturing method of claim 9, wherein after said substrate and said two auxiliary members are joined together, a closure is joined to one end face of said substrate and said two auxiliary members in said tape running direction, closing an open side of said clearance.

13. The magnetic head manufacturing method of claim 8, wherein said substrate and said two auxiliary members are joined together with an adhesive.

14. The magnetic head manufacturing method of claim 8, wherein said substrate and said two auxiliary members are joined together such that said substrate projects from said two auxiliary members toward said magnetic tape.

15. A magnetic tape device comprising a magnetic tape driving means and a magnetic head, wherein
said magnetic tape driving means is adapted to run a magnetic tape along a tape running direction,
said magnetic head is a magnetic head according to any one of claims 1 to 7, and
said tape bearing surface is adapted to be kept in sliding contact with said magnetic tape for writing data on said magnetic tape with said recording element and reading data from said magnetic tape with said reproducing element.
